(19) United States
(12) Patent Application Publication
(10) Pub. No.: US 2004/0043142 A1
(43) Pub. Date: Mar. 4, 2004

(54) Systems and methods for treating glass

(76) Inventors: William R. Birch, Fontainebleau (FR); Lori L. Hamilton, Horseheads, NY (US); Edward J. Sever, Corning, NY (US); Youchun Shi, Horseheads, NY (US)

Correspondence Address: CORNING INCORPORATED, SP-TI-3-1, CORNING, NY, 14831

(21) Appl. No.: 10/232,280

(22) Filed: Aug. 29, 2002

(51) Int. Cl. B05D 1/00

(52) U.S. Cl. 427/164; 156/345.1

(57) ABSTRACT

The present invention relates to methods and systems for temporarily protecting LCD glass by (1) coating the glass material with a hydrophobic coating and (2) removing the hydrophobic coating and any contaminants by either plasma cleaning, pyrolysis cleaning, or a combination of both cleaning methods.

### BACKGROUND OF THE INVENTION

1. Field of the Invention

The present invention relates generally to systems and methods for temporarily protecting glass materials, and particularly to systems and methods for temporarily protecting liquid crystal display (“LCD”) glass.

2. Technical Background

Glass materials are often used in the production of electronic display devices, including LCDs, televisions, computer monitors, personal digital assistants, cellular phones, and numerous other display devices. The production of electronic display devices is highly sensitive to the cleanliness of the materials used in their manufacture. For example, glass used in the manufacture of LCD devices is highly sensitive to contaminants, which may be introduced from the period that the raw LCD glass is freshly produced until the LCD glass is processed and manufactured into an LCD device. The various contaminants present in the atmosphere, including organic and inorganic materials, lint, glass chips, dust and particulates often contaminate the surface of raw LCD glass shortly after production. These contaminants present significant challenges to LCD device production and therefore care must be taken to clean and protect LCD glass prior to manufacture of LCD devices.

To date, liquid cleaning methods have been the primary methods for LCD glass cleaning. These liquid cleaning methods include acid solution cleaning and alkaline solution cleaning. Although these liquid cleaning methods are capable of removing contaminants, they are also fairly complicated, use large amounts of liquid and surfactants, and generate a large amount of waste, which is not environmentally acceptable. Additionally, if ionic, organic, or inorganic contaminants chemically bond to the glass surface, liquid cleaning methods are often ineffective in removing these bound contaminants. Moreover, liquid cleaning steps generally require a drying step. This drying step has the potential of introducing new contaminants to the glass surface and adds additional expense to the overall process.

Dry cleaning methods, on the other hand, have several advantages over liquid cleaning methods and overcome several of the problems presented by the liquid cleaning methods, including the ability to remove some inorganic and organic contaminants. Such dry cleaning methods include, laser cleaning, ultraviolet (UV)/ozone cleaning, and carbon dioxide snow cleaning.

Laser cleaning, for example, uses pulsed thermal energy to remove contamination. While laser cleaning provides the ability to remove some inorganic and organic contaminants, it also has many drawbacks. First, laser cleaning has not proven effective in removing polymer contaminants. Second, laser cleaning is time consuming. Third, laser cleaning often causes discoloration of the glass. Fourth, high laser energy, often required for efficient removal of contaminants, may cause significant damage to the glass surface.

Carbon dioxide snow is another dry cleaning technique, which uses small dry ice particles in a high velocity stream of gas to interact with contaminants on the surface of glass materials. In this method, the contaminants are liberated from the surface and removed by a high velocity gas stream. A drawback of this method is the requirement of a dry environment to avoid condensation of humidity and the re-deposition of contaminants. Further, it has been found that it is very challenging to clean large glass sheets, such as those used in the manufacture of LCD glass, using dry cleaning techniques such as carbon dioxide snow cleaning and laser cleaning techniques.

In addition to cleaning the glass materials, it is often desirable to coat the glass materials to provide protection from scratches as well as the adhesion of certain contaminants. For example, a water repelling protection layer can reduce adhesion of inorganic particles such as glass chips. Many of the liquid and dry cleaning methods are, however, ineffective in removing the coatings on the glass surfaces.

UV/ozone cleaning is an alternative dry method, which is capable of removing organic contamination and thin organic protection layers. UV light, however, causes discoloration of glass substrates and is ineffective in removing inorganic particles. Moreover, UV release coatings are expensive and UV/ozone is not very effective at removing mass organic residues, such as a UV release coating layer, completely. In fact, UV/ozone cleaning will remove 1 nm thick coatings with no visible residue, but it does not effectively remove thicker coatings, on the order of 100 nm to 1 micron. These thick coatings are often required for effective scratch protection.

Accordingly, it would be desirable to provide systems and methods capable of providing an effective coating that adequately protects glass materials, such as raw LCD glass, from scratches and all types of contamination while simultaneously providing for the removal of the coating without adverse affects on the glass material. The present invention, several embodiments of which are described below, provides such systems and methods.

### SUMMARY OF THE INVENTION

The present invention relates generally to temporarily protecting glass materials using particle-repelling coatings and subsequently removing the coatings using a dry cleaning method such as plasma cleaning or pyrolysis cleaning. Hydrophobic coatings can prevent particles from adhering to a glass surface directly and also increase the scratch resistance of the glass material. Plasma and pyrolysis cleaning have been determined to be effective at removing the coating and other contaminants. Since these are dry cleaning methods, no liquid waste is generated.

Compared to laser cleaning, plasma cleaning and pyrolysis cleaning can be controlled so as to minimize glass damage and discoloration. Compared to UV/ozone cleaning, the plasma cleaning and pyrolysis cleaning are more aggressive for organic residue removal. The coatings used for plasma cleaning and pyrolysis cleaning are also typically much less expensive than UV release coatings.

Plasma cleaning and pyrolysis cleaning also remove thicker coatings up to 10 microns. Additionally, a combination of plasma cleaning and pyrolysis cleaning expedites the removal of thicker coatings and various forms of contaminants, while leaving behind virtually no visible residue.

According to one aspect, the present invention includes a method for temporarily protecting a glass material comprising the steps of applying a hydrophobic coating, having a thickness at least equal to a monolayer of the hydrophobic coating, to the glass material and removing the hydrophobic coating by a method selected from the group consisting of plasma cleaning and pyrolysis cleaning. The glass material, prior to coating, has a water contact angle less than or equal to a first level. The glass material has a water contact angle less than or equal to a second level subsequent to the removing step. The second level is within 20% of the first level. The removing step can also be a combination of plasma cleaning and pyrolysis cleaning.

In another aspect, the present invention includes a method for temporarily protecting freshly produced LCD glass comprising the steps of (1) providing freshly produced LCD glass at a temperature greater than about 200° C.; (2) cooling the LCD glass to a temperature of at least about 150° C.; (3) coating the LCD glass with a hydrophobic coating to a thickness of about 0.01 to 10 microns after the LCD glass has cooled to a temperature of less than about 150° C.; and (4) removing the hydrophobic coating from the LCD glass by a method selected from the group consisting of plasma cleaning and pyrolysis cleaning. The removing step can also be a combination of plasma cleaning and pyrolysis cleaning.

In yet another embodiment, the present invention includes a system for temporarily protecting LCD glass material comprising a coating application unit whereby a coating is applied to the LCD glass material and a dry cleaning unit whereby the coating is subsequently removed from the glass material. The LCD glass material has a water contact angle less than a first level prior to application of said coating and a water contact angle at a second level subsequent to said removal of said coating. The second level is less than or equal to the first level.

Additional features and advantages of the invention will be set forth in the detailed description which follows and, in part, will be readily apparent to those skilled in the art from that description or recognized by practicing the invention as described herein, including the detailed description which follows, the claims, as well as the appended drawings.

It is to be understood that both the foregoing general description and the following detailed description of present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWING

FIG. 1 is a flow diagram of a method in accordance with one embodiment of the present invention.

### DETAILED DESCRIPTION OF THE PREFERRED EMBODIMENTS

Reference will now be made in detail to the present preferred embodiments of the invention, an example of which is illustrated in the accompanying figure.

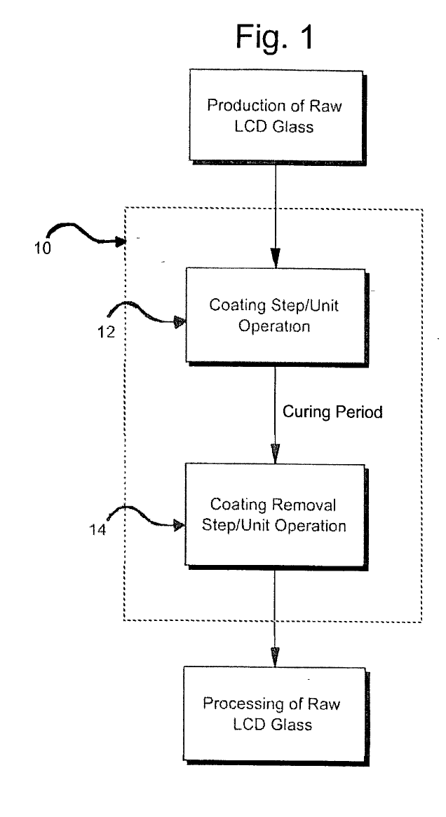

In accordance with the invention, the present embodiments are generally directed to systems and methods for temporarily protecting a glass material from contamination and scratching by applying a coating to the glass material and removing the coating after a period of time. More particularly, as shown in FIG. 1, the present embodiments are generally directed to methods in which freshly produced, raw LCD glass is coated with a protective coating. The coating is cured for a period of time and subsequently removed from the LCD glass prior to any additional processing of the raw LCD glass into, for example, LCD screens. While the embodiments of the invention will be described with respect to protecting raw LCD glass for the time period prior to use in the manufacture of LCD displays, one of ordinary skill in the art will appreciate that the present invention is applicable to other glass materials and other processes.

Referring to FIG. 1, in accordance with one embodiment of the invention, a method 10 for temporarily protecting a glass material is provided comprising the steps of applying a hydrophobic coating to the glass material 12 and removing the hydrophobic coating from the glass material 14 by a dry cleaning process selected from the group consisting of plasma cleaning or pyrolysis cleaning. A curing step 16, or storage step, can occur between the coating step 12 and removing step 14.

Prior to treatment 12, the glass material has a water contact angle less than or equal to a first level. The measurement of the water contact angle is a known method of measuring the amount of impurities on a surface. A surface having a small water contact angle is clean with few impurities. In general, as the impurities on the surface increase, so does the water contact angle. Contact angle measurements can be made with known equipment and through known methods, such as those available through Ramé-Hart, Inc., 8 Morris Avenue, Mountain Lakes, N.J. 07046, USA.

One such method includes the use of a charge-coupled device (“CCD”) camera connected to a monitor and a printer. Drops of water are placed on the glass surface with a Gilmont GS-1200 micrometer syringe. Pictures of the drops are taken with the CCD camera. The angle created by the edge of the water drop and the glass surface (the contact angle) is then measured manually from the pictures with a protractor. Preferably, the glass surface is measured with four drops over a 5-inch-by-5 inch area and the contact angles are then averaged.

Another method includes the use of a contact angle analyzer available through ThermoCahn, Madison, Wis. 53711, USA, in which the contact angle analyzer uses a CCD camera to take pictures of the water drops on the glass surface and uses a computer to analyze the contact angles of the drops. The contact angles are often measured to a fraction of a degree. The variation in measurements is, however, often plus or minus three degrees, and, therefore, the contact angle measurements are typically reported to the nearest degree, plus or minus three degrees.

Yet another method includes the use of a manual contact angle analyzer from Ramé-Hart, Inc., 8 Morris Avenue, Mountain Lakes, N.J. 07046, USA. This analyzer enables the user to make contact angle determinations in a moment's time. Its microscope produces a sharply defined image of a sessile or pendant drop, which is observed as a silhouette. The contact angle of the drop is then measured manually, or through use of known software programs.

The first level, in the case of raw LCD glass, is the water contact angle measured shortly after the raw glass is produced, and before the coating step 12, and has therefore a low level of adsorbed organic contaminants. Typically, this first level is less than ten degrees. Subsequent to the coating removal step 14, the water contact angle of the glass material is measured again, and a second level is determined. The second level is preferably less than or equal to the first level, thereby showing that the coating and removal steps keep the glass surface protected and effectively free of contaminants. In certain instances the second level may be greater than the first level, as long as the LCD glass is commercially acceptable with such a second level reading of the water contact angle. Generally, the second level should always be within 20% of the first level, more preferably within 15% of the first level and most preferably within 10% of the first level.

The hydrophobic coating applied to the glass material has a thickness at least equal to a full-coverage monolayer of the hydrophobic coating, thereby covering the entire surface of the glass material. The thickness of a monolayer can be measured by determining the average length or diameter of the molecules or particles making up the monolayer. Thus, the minimum thickness of the coating in the present invention varies depending on the composition of the hydrophobic coating. A coating having the minimum thickness is often desirable from an economic standpoint because it provides for complete coverage of the glass surface while minimizing the amount of coating material used. This thin coating, however, also provides less protection against scratching and contamination. Thus, in situations where the glass material is likely to be treated less carefully, or sits for a longer period of time prior to removal of the coating, a thicker coating can be more effective.

In general, the greater the thickness of the coating, the greater the protection against scratching and contamination. However, if the coating is applied too thick, then it will be difficult to completely remove and will also result in higher cost for the overall process. Accordingly, a coating having the right composition and thickness is desirable from a practical and economic standpoint. It has been determined by the inventors of the present invention that the coating thickness should be between a monolayer of the coating material and about 10 microns. More preferably, the coating thickness should be between about 0.01 and 0.5 microns.

The hydrophobic coating materials are selected in order to provide a satisfactory barrier against particle adhesion and scratch resistance characteristics required by a particular application. Thus, the hydrophobic coating materials, once applied to the LCD glass, should protect the glass surface from direct particle adherence.

The hydrophobic coating materials should also be capable of efficient removal from the LCD glass through the methods discussed in more detail below. In particular, the hydrophobic coating materials should be capable of being removed from the glass surface without a significant effect on the glass surface itself, (e.g., discoloration or roughening of the surface) or incomplete removal from the surface.

Acceptable hydrophobic coating materials are thus selected according to various desired properties of the LCD glass surface subsequent to the removal of the hydrophobic coating material. For example, a particular hydrophobic coating material may be selected such that it provides a level of protection for the LCD glass surface that makes it possible to achieve, after removal of the hydrophobic coating, a target water contact angle, surface roughness, and particle density.

It has been determined that the hydrophobic coating material should result in a water contact angle measurement greater than fifty degrees after the excess coating material has been washed off the glass surface. More preferably, the coating material is selected such that, after application of the coating material, the glass surface has a water contact angle of greater than sixty degrees. Most preferably, the coating material is selected such that, after application of the coating, the glass surface has a water contact angle of greater than ninety degrees. The coating materials yielding a surface having the higher water contact angles are more desirable because this helps to avoid problems such as capillary condensation between glass chips and the glass substrate. Additionally, for hydrophobic organic coatings, the lower the contact angle, the more of the glass surface that is exposed. This affects the level of protection provided by the hydrophobic coatings.

Tables I and II show various exemplary acceptable surfactant and polymeric coatings and the measured water contact angles of various surfaces, including LCD glass, coated with these materials. Table I includes the concentration of the coatings applied to the glass surface. Table II shows either the advancing contact angle or the equilibrium contact angle for particular polymeric coatings and other organic coatings. The advancing contact angle is the largest angle observable when a liquid droplet is increased in size. The equilibrium contact angle corresponds to the lowest energy state for a system, or when the droplet resting on a surface is at equilibrium.

Regardless of whether the measured contact angle is the average contact angle, advancing contact angle, or equilibrium contact angle, it is preferable that the coatings applied to LCD glass in Tables I and II result in a contact angle greater than fifty degrees.

TABLE I
Water contact angle of various surfactant coatings on LCD glass.

| | Concentrations | Average |
|---|---|---|
| | of Spray | Equilibrium |
| Chemical Name | Solutions (w/w %) | Contact Angle (°) |
| Ammonyx MO | 1 | 62 |
| Amphosol CDB | 1 | 67 |
| ARQUAD DMCB-80 | 1 | 60 |
| BRIJ ®35 | 1 | 55 |
| BTC 1010 (Didecyl Trimethy1 | 0.1 | 58 |
| ammonium Chloride) | 1 | 73 |
| Dimethyldicocoammonium | 0.1 | 70 |
| Chloride (CoCoDMA) | | |
| Didodecyldimethyl | 0.1 | 68 |
| ammonium Bromide | 1 | 66 |
| Dodecyltrimethylammonium | 0.02 | 55 |
| Bromide | | |
| Cetyltrimethylammonium | 0.02 | 76 |
| Bromide | | |
| Rewoteric am B-14 LSU | 1 | 66 |
| Rewoteric am Cas-15 | 1 | 74 |
| Rewoteric am HC | 1 | 68 |
| Tetradecyltrimethylammonium | 0.1 | 61 |
| Bromide | 1 | 62 |
| Varonic K-202 | 1 | 87 |
| Varox 1770 | 0.1 | 62 |
| | 1 | 62 |

TABLE II
Water contact angle of polymer materials
and organic compounds on various substrates.

| | Advancing | |
|---|---|---|
| | Contact | Equilibrium |
| Chemical Name | Angle (°) | Contact Angle (°) |
| Poly(chlorotrifloroethylene)-butyrate | 89 | |
| Poly(dimethyl siloxane) | 103 | |
| Poly(chlorotrifloroethylene) | 103 | |
| Octadecyltrimethyl silane (self- | | 106 |
| assembled monolayer) | | |
| Fluorosilane monolayer prepared from | 109 | |
| Cl₃Si(CH₂)₂(CF₂)₇CF₃ | | |
| Poly(methyl methacrylate) | | 80 |
| Paraffin wax | | 108 |
| Perflorodecanoic acid | | 102 |
| Polycarbonate | 84 | |
| Polyoxymethylene | 79 | |
| Polystyrene | 91 | |

The surface roughness of the LCD glass surface can be measured by known processes such as atomic force microscopy. The hydrophobic coating materials are selected such that upon removal from the LCD glass by the methods discussed below, the LCD glass surface has a surface roughness Rms as measured by atomic force microscopy of less than 0.36 nm on a 20-micron-by-20-micron area.

The coating materials also can be selected such that upon removal of the coating from the surface, the LCD glass surface has a particle density that is less than or equal to 0.02 particles/cm² for particles greater than 10 microns. The particle density on the surface is measured by known methods, such as by laser scattering methods. One particular method of measuring scattered light includes the use of a Hitachi Deco GI-4800 Inspection System available from Hitachi Electronics Engineering Co., Ltd., Tokyo, Japan. The Hitachi-Deco system uses two laser diodes operating at 780 nm. The laser diodes direct light onto the LCD glass surface and any particles present on the LCD glass surface, or inclusions on the surface, will cause light to scatter. Two separate detectors are present to detect this scattered light. The detected scattered light is then analyzed to determine the presence of and density of any particles (contaminants).

Exemplary acceptable hydrophobic coating materials utilized in the coating step include hydrophobic polymers, such as polyurethane, polyethylene, polyethylene chloride, and polyesters; rubbers; modified hydrophobic polysaccharides, such as starch octenyl succinate ester; waxes, including natural waxes such as beeswax, candelilla wax, carnauba wax, rice bran wax, mineral wax, petroleum wax, and synthesized waxes, such as polyethylene wax and Fisher-Tropsch wax; drying oils including natural drying oils such as linseed oil, tung oil, and synthesized/modified drying oils such as pentaerythrythritol tetraester of soybean fatty acids and maleated oils; fluorocarbons, fluorohydrocarbons; silanes having an aliphatic hydrocarbon chain, such as octadecyltrimethoxysilane or polydimethyl siloxane; cationic surfactants, such as cocoDMA, a quaternary ammonium that contains an aliphatic hydrocarbon chain of 8 to 18 carbons; anionic surfactants, such as oleic acid, capric acid, and steric acid; non-ionic surfactants, such as Brij® 35 and esters of poly(chlorotrifluoroethylene); and amphoteric surfactants, such as Rewoteric am HC and graphite. Any number of combinations or mixtures of the above coating materials is also contemplated by the present invention.

In the case of LCD glass, the coating is applied to freshly produced LCD glass. Initially, the LCD glass is provided as freshly produced LCD glass at a temperature greater than about 200° C. The LCD glass is allowed to cool to a temperature of less than about 150° C. prior to the coating step. The LCD glass can also be allowed to cool to room temperature prior to the application of the coating material.

Once the LCD glass has cooled to the desired predetermined temperature, the coating is then applied to the LCD glass. The coating material can be applied to the glass material in any form known to those of ordinary skill in the art, including in the form of melt, a solution in an organic solvent, an emulsion in water, or a solution in a water/organic solvent mixture. In the case of a water/organic solvent mixture, such as water or a water/isopropanol mixture, the amount of isopropanol is preferably less than 50% by volume, more preferably less than 20% by volume, and most preferably approaching 100% water. Other simple alcohols and other compounds known to those skilled in the art can be substituted for isopropanol.

Once the solvent mixture is obtained, the coating material is then mixed with the solvent mixture such that the concentration of the coating solution is between about 0.01% and 20% by weight, more preferably 0.1% to 10% by weight. The concentration of the coating solution, and accordingly the solvent/coating ratio, should be selected to ensure coating uniformity while minimizing evaporated solvent. Alternatively, the quantity of evaporated solvent can be adjusted to cool the glass surface and reduce thermal degradation of the coating.

The hydrophobic coatings are applied to a glass surface using known methods such as dip coating, air knife coating, spin coating, and spray coating. For raw or freshly produced glass in the form of sheets, the preferred method for applying the hydrophobic coatings is by spray coating. Spray coating can be accomplished through the use of a Binks 115 spray gun available from ITW Industrial Finishing, Glendale Heights, Ill., USA.

Referring back to FIG. 1, after the coating is applied 12, the coating can be cured 16 by known methods such as cooling, drying, heating, or exposure to ultraviolet (UV) light. The length of the curing process depends on factors including the following: the particular hydrophobic coating selected; the thickness of the coating; the temperature of the LCD glass; and other atmospheric conditions. Those of ordinary skill in the art will appreciate that other methods of curing are also acceptable.

Referring back to FIG. 1, after the glass material is coated 12 for protection from scratching and contamination and cured 16, the coating is removed 14 using a dry cleaning process selected from the group consisting of plasma cleaning and pyrolysis cleaning, or a combination of both. In certain instances it may be desirable to use additional known cleaning methods, such as liquid cleaning methods, in combination with the dry cleaning methods mentioned above. For example, prior to the coating step 12, a liquid cleaning step is often desirable to remove any glass chips present on the surface of the glass.

The amount of time between the coating step 12 and removal step 14 varies depending on the particular application of the process. Often, this is dependent on factors such as storage and shipping considerations. Typically, the coating will be removed prior to use of the raw LCD glass in the manufacture of, for example, LCD screens. Depending on the intended use of the raw LCD glass, the time period between coating 12 and removal 14 can be up to one year. The coating material should be selected such that it does not have deleterious effects on the glass and provides the protective coating required for periods as long as a year. The coating materials described in conjunction with embodiments of the present invention are believed to provide sufficient protection for periods as long as a year.

Plasma cleaning is a process in which gas plasma is used to remove organic contaminants such as oil and waxes, as well as some inorganic thin films or impurities from surfaces. A plasma is a collection of positive, negative, and neutral particles in which the density of the negatively charged particles is equal to the density of the positively charged particles. Plasma cleaning unit operations can be purchased from known companies such as PLASMAtech, Inc., located at 1895 Airport Exch. Blvd., #190 Erlanger, Ky. 41018, USA.

The plasma gas is selected from the group consisting of oxygen, air, water, dinitrogen oxide, ammonia, hydrogen, tetrafluoromethane, sulfur hexafluoride, argon, helium, and mixtures of these gases. Other gases can be substituted as known by those of ordinary skill in the art.

Proper selection of the process gas often results in optimum contaminant removal. For example, if the contaminants on a glass surface are thought to be primarily organic materials, use of an oxidizing gas, such as oxygen, air, water, and dinitrogen oxide is preferred. Other contaminants might require an active gas such as ammonia, a reducing gas such as hydrogen, fluorinated gases such as tetrafluoromethane and sulfur hexafluoride, or noble gases such as argon and helium.

It has been determined that mixtures of plasmas are often beneficial in the circumstances where there are multiple types of contaminants, for example, organic and inorganic contaminants. Since inorganic contaminants are non-reactive with these gases, use of a reducing gas, such as hydrogen, prior to use of the oxidizing gases or noble gases generally provides a more efficient removal of both organic and ionic contaminants.

Plasma cleaning is an environmentally sound alternative to other dry cleaning methods using ozone-depleting substances, which are no longer acceptable methods. In general, plasma cleaning uses inert gases that are ozone friendly, nontoxic, noncaustic, and frequently inexpensive. Carbon dioxide emissions from the plasma cleaning process are not regulated as stringently as many other chemicals, so no emissions control devices are needed, other than the proper venting of exhaust gases to the atmosphere.

Plasmas can exist in a wide variety of temperatures and pressures. Plasmas at temperatures less than 60° C. and pressures of 0.15 to 5 mm Hg are referred to as “cold” plasmas. Cold plasmas are preferred for coating removal because the operating conditions required are achieved more easily than for plasmas at higher temperatures and pressures, however, other plasmas can also be used in accordance with embodiments of the present invention.

Plasmas can be generated either by a direct current voltage or by radio frequency in the range of 1 KHz to 100 GHz. A particularly preferred radio frequency is 13.56 MHz. Other benefits of plasma cleaning include that it is generally inexpensive to operate, generates no regulated waste streams, and can produce clean surfaces in very short time periods, often minutes.

According to another embodiment, the plasma cleaning step is conducted in a vacuum chamber. In this embodiment, the plasma cleaning operation begins with the placement of the glass material in a vacuum chamber. The air is then evacuated from the chamber to base vacuum pressure. The process gas (or gases) is then introduced into the chamber. The chamber is next irradiated with energy to produce the plasma. In the presence of plasma, organic contaminants on the glass surface are converted to carbon monoxide, carbon dioxide, and water vapor, which are drawn from the plasma chamber by a vacuum pump.

After a sufficient time period, energy and process gas flow are shut off and the chamber is then purged with a nonreactive gas such as nitrogen, to remove all traces of volatile compounds. Finally the chamber is returned to atmospheric pressure. A cleaning cycle usually lasts from about 30 seconds to about 15 minutes and is largely a function of the glass material loaded in the plasma chamber. Plasma cleaning in a vacuum facilitates uniformity through dispersion of the plasma and therefore quickly and effectively cleans the entire surface of the glass material simultaneously and evenly.

Another preferred dry cleaning method is pyrolysis cleaning. Pyrolysis cleaning is a process that involves heating the glass material to a temperature above 300° C., more preferably between about 500° C. and 700° C., and most preferably between about 550° C. and 650° C., for about 30 minutes or more. A typical cycle can consist of a rise in temperature from room temperature to greater than 500° C. over four hours, followed by a period of between about two hours and five hours, and a return to room temperature over five hours. The slow increases and decreases in temperature are designed to avoid glass breakage from thermal shock. This process generates few waste products. It relies on the degradation and desorbtion of organic contaminants from the surface of the glass. It has also been found to be effective in increasing the wettability of glass surfaces contaminated with any organic pollution, including such molecules as PDMS or fluorocarbons.

Pyrolysis cleaning may generate soot residue and is generally not effective in removing this soot. When using this process, it is important that the residual contamination on the glass surface be of the order of nanometer thickness or less in order to avoid macroscopic residues on the glass surface, such as carbon or other inorganic matter.

Pyrolysis cleaning unit operations can be purchased from known companies such as, Advanced Vacuum Systems, Inc. (“AVS”) located at 60 Fitchburg Road, Ayer, Mass. 01432, USA.

Although plasma cleaning and pyrolysis cleaning are often effective for removing most coatings and contaminants used in the production and protection of LCD glass, there are situations in which these unit operations, a combination of pyrolysis cleaning with plasma cleaning increases the rate of organic coating removal. Such an increase in the rate of coating removal translates to increased overall process efficiency and/or lower process cost.

The combination of these dry cleaning methods can be combined into a single step in which the plasma cleaning is conducted in a pyrolysis cleaning oven. This embodiment can be performed simultaneously or in series within the same oven. This embodiment requires a specially made unit that is capable of both plasma cleaning and pyrolysis cleaning.

Additionally, these dry cleaning methods can be performed separately in series in which the LCD glass is first cleaned by plasma cleaning and then by pyrolysis cleaning, or vice versa. The benefit of this embodiment is that commercial unit operations can be purchased from the companies described above and special unit operations need not be specifically designed. In either embodiment, the combination of the two dry cleaning methods yields a glass material that is substantially free of all contaminants (i.e., has a contact angle of less than ten degrees).

The present invention also provides for a system for temporarily protecting a glass material. The system is comprised of a coating application unit whereby a coating is applied to the glass material and a dry cleaning unit whereby the coating is subsequently removed from the glass material after a predetermined amount of time. For purposes of this application, the terms “unit” and “process unit” are defined as an apparatus that is capable of stand-alone, independent operation, or that is capable of being connected to other units to create an overall process or system.

The coating application unit is capable of applying a hydrophobic coating, described in more detail above, to a glass material. The coating application unit preferably coats the glass materials by spin coating, dip coating, knife coating, or spray coating. Most preferably, in the case of LCD glass, the coating application unit comprises a spray coating apparatus.

The dry cleaning unit is either a plasma cleaning unit, a pyrolysis cleaning unit, or a unit capable of cleaning the glass material by a combination of both plasma cleaning and pyrolysis cleaning.

### EXAMPLES

The invention will be further clarified by the following examples.

### Example 1

1. Coating Step

a. Spray 35% aqueous emulsion of polydimethyl siloxane (available from ABCR GmbH & C. KG, Karlsruhe, Germany) on 200° C. LCD glass.

b. Cure for a period of at least five minutes. The result is a coated layer preventing particle adhesion to the LCD glass.

2. Coating Removal Step

Place coated glass in a plasma cleaner made by Plasma Etch (Carson City, NV) at 5 mTorr for a period of five minutes.

3. Inspection Step

Measure the water contact angle using a Ramé-Hart Contact Angle goniometer and particle contamination with Hitachi Deco GI-4800 Inspection System.

### Example 2

1. Coating Step

a. Spray BW-547A paraffin wax emulsion solution (available from Blended Waxes, Inc., Oshkosh, Wis., USA) on 100° C. LCD glass.

b. Cure for a period of at least 5 minutes. The result is a coated layer preventing particle adhesion to the LCD glass.

2. Coating Removal Step

Place coated glass in a vacuum furnace manufactured by AVS, Inc. and heat at 600° C. for a period of one hour.

3. Inspection Step

Measure the water contact angle using a Ramé-Hart Contact Angle goniometer and particle contamination with Hitachi Deco GI-4800 Inspection System.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for temporarily protecting a glass material having a water contact angle less than or equal to a first level comprising the steps of
applying a hydrophobic coating material to said glass material, said hydrophobic coating material having a thickness at least equal to a monolayer of said hydrophobic coating material; and
removing said hydrophobic coating, said removing step being selected from the group consisting of plasma cleaning and pyrolysis cleaning, said glass material having a water contact angle less than or equal to a second level subsequent to said removing step, said second level being within 20% of said first level.

2. The method of claim 1, wherein said hydrophobic coating is selected from the group consisting of hydrophobic polymers, rubbers, modified hydrophobic polysaccharides, waxes, drying oils, fluorocarbons, fluorohydrocarbons, silanes having an aliphatic hydrocarbon chain, cationic surfactants, anionic surfactants, non-ionic surfactants, and amphoteric surfactants.

3. The method of claim 1, wherein said coating step applies a coating to at least two surfaces of said glass material.

4. The method of claim 1, wherein said thickness of said coating is between 0.01 and 10 microns.

5. The method of claim 1, wherein said thickness of said coating is between 0.01 and 0.5 microns.

6. The method of claim 1, wherein said removing step is a combination of plasma cleaning and pyrolysis cleaning.

7. The method of claim 1, wherein said removing step comprises plasma cleaning.

8. The method of claim 7, wherein said plasma cleaning step further comprises utilizing a gas selected from the group consisting of oxygen, air, water, dinitrogen oxide, ammonia, hydrogen, tetrafluoromethane, sulfur hexafluoride, argon, and helium.

9. The method of claim 7, wherein said plasma cleaning step further comprises utilizing a combination of gases selected from the group consisting of oxygen, air, water, dinitrogen oxide, ammonia, hydrogen, tetrafluoromethane, sulfur hexafluoride, argon, and helium.

10. The method of claim 1, wherein said removing step comprises a first pyrolysis cleaning step and a second plasma cleaning step.

11. The method of claim 7, wherein said plasma cleaning step is conducted in a vacuum.

12. The method of claim 1, wherein said removing step is pyrolysis cleaning.

13. The method of claim 12, wherein said pyrolysis cleaning is conducted at a temperature between about 500° C. and 700° C.

14. The method of claim 12, wherein said pyrolysis cleaning is conducted at a temperature between about 550° C. and 650° C.

15. The method of claim 14, wherein said pyrolysis cleaning is conducted for a period of between 2 and 5 hours.

16. The method of claim 1, wherein said removing step comprises a combination of pyrolysis cleaning and plasma cleaning.

17. The method of claim 1, wherein said first level is a water contact angle of ten degrees.

18. The method of claim 1, wherein said second level is within 15% of said first level.

19. The method of claim 1, wherein said glass material has a water contact angle of at least fifty degrees subsequent to applying step.

20. A method for temporarily protecting freshly produced LCD glass comprising the steps of
providing said freshly produced LCD glass at a temperature greater than about 200° C.;
cooling said LCD glass to a temperature of at least about 150° C.;
coating said LCD glass with a hydrophobic coating to a thickness of about 0.01 to 10 microns after said LCD glass has cooled to a temperature of at least about 150° C.; and
removing said hydrophobic coating from said LCD glass, said removing step being selected from the group consisting of plasma cleaning and pyrolysis cleaning.

21. A system for temporarily protecting LCD glass material comprising
a coating application unit whereby a coating is applied to said LCD glass material, said LCD glass material having a water contact angle less than a first level prior to application of said coating; and
a dry cleaning unit whereby said coating is subsequently removed from said glass material, said LCD glass material having a water contact angle at a second level subsequent to said removal of said coating, said second level being less than or equal to said first level.

22. The system of claim 21, wherein said coating is a hydrophobic coating.

23. The system of 22, wherein said hydrophobic coating is selected from the group consisting of hydrophobic polymers, rubbers, modified hydrophobic polysaccharides, waxes, drying oils, fluorocarbons, fluorohydrocarbons, silanes having an aliphatic hydrocarbon chain, cationic surfactants, anionic surfactants, nonionic surfactants, and amphoteric surfactants.

24. The system of claim 21, wherein said coating application unit applies a coating to at least two sides of said glass material.

25. The system of claim 21, wherein said coating is a monolayer of hydrophobic material.

26. The system of claim 21, wherein said coating is between 0.01 and 10 microns.

27. The system of claim 21, wherein said coating is between 0.01 and 0.5 microns.

28. The system of claim 21, wherein said dry cleaning unit is selected from the group consisting of a plasma cleaning unit or a pyrolysis cleaning unit.

29. The system of claim 21, wherein said dry cleaning unit is a combination of a plasma cleaning unit and a pyrolysis cleaning unit.

30. The system of claim 21, wherein said dry cleaning unit is a pyrolysis cleaning unit.

31. The system of claim 30, wherein said plasma cleaning unit utilizes gas selected from the group consisting of oxygen, air, water, dinitrogen oxide, ammonia, hydrogen, tetrafluoromethane, sulfur hexafluoride, argon, and helium.

32. The system of claim 30, wherein said plasma cleaning unit is a vacuum plasma cleaning unit.

33. The system of claim 21, wherein said first level is a water contact angle of ten degrees.

34. The system of claim 21, wherein said second level is within 10% of said first level.

35. The system of claim 21, wherein said glass material has a water contact angle of at least fifty degrees subsequent to applying step.

36. A method for temporarily protecting a glass material having a water contact angle less than or equal to a first level comprising
step for applying a hydrophobic coating material to said glass material, said hydrophobic coating material having a thickness at least equal to a monolayer of said hydrophobic coating material; and
step for removing said hydrophobic coating, said removing step being selected from the group consisting of plasma cleaning and pyrolysis cleaning, said glass material having a water contact angle less than or equal to a second level subsequent to said removing step, said second level being within 20% of said first level.
